(19) United States
(12) Patent Application Publication
(10) Pub. No.: US 2025/0385453 A1
(43) Pub. Date: Dec. 18, 2025

(54) CONNECTOR-EQUIPPED WIRE HARNESS AND METHOD OF MANUFACTURING SAME

(71) Applicant: Yazaki Corporation, Tokyo (JP)

(72) Inventor: Masafumi WATANABE, Shizuoka (JP)

(73) Assignee: Yazaki Corporation, Tokyo (JP)

(21) Appl. No.: 19/229,012

(22) Filed: Jun. 5, 2025

(30) Foreign Application Priority Data
Jun. 17, 2024 (JP) 2024-097554

(51) Int. Cl. H01R 12/77; B60R 16/02; H01R 13/422; H01R 43/20

(52) U.S. Cl. CPC H01R 12/774; B60R 16/0215; H01R 13/422; H01R 43/205

(57) ABSTRACT

A connector-equipped wire harness includes: a flat wiring member including an electric conductor; a flat wiring member-dedicated terminal including an electric connection portion that is electrically connected to a mating terminal and a narrow insertion portion that clamps the flat wiring member; and a connector housing that nips the flat wiring member-dedicated terminal. By nipping the flat wiring member-dedicated terminal by the connector housing while the flat wiring member is inserted into the narrow insertion portion, the electric conductor is clamped by the narrow insertion portion and the flat wiring member-dedicated terminal and the electric conductor are electrically connected to each other.

### CROSS REFERENCE TO RELATED APPLICATION

The present application is based on, and claims priority from the prior Japanese Patent Application No. 2024-097554, filed on Jun. 17, 2024, the entire contents of which are incorporated herein by reference.

### TECHNICAL FIELD

The present disclosure relates to a connector-equipped wire harness and a method of manufacturing the same.

### BACKGROUND

As a method of attaching a terminal to a terminal end of a flat wiring member such as a flexible printed circuit (FPC) and a flexible flat cable (FFC), a method that uses a consumer-grade connector and a method that involves soldering are available. However, when a wire harness to which a terminal is attached by those methods is used in a vehicle, the terminal may be detached from a flat wiring member due to vibration, which causes a problem of insufficient terminal retention force. Thus, a method that uses a piercing terminal is available as an alternative method of attaching a terminal to a terminal end of a flat wiring member.

JP 2005-197198 A discloses a method of connecting a piercing terminal to a flat flexible cable being a flat wiring member. When connecting the piercing terminal, a protruding part of the piercing terminal is caused to penetrate a flat electric conductor of the flat flexible cable and is bent in a width direction, and a distal end of the protruding part is pressed against the flat flexible cable.

### SUMMARY OF THE INVENTION

When a piercing terminal as disclosed in JP 2005-197198 A is used, the piercing terminal and the terminal end of the flat wiring member are first connected to each other, and then the piecing terminal is accommodated in a housing of a connector. Further, when a plurality of piercing terminals are used, it is required to connect each of the piercing terminals individually to the electric conductor of the flat wiring member. Thus, connection work between the piercing terminal and the flat wiring member is required for each of the piercing terminals, which makes assembly work complicated. Further, when the piercing terminal is caused to penetrate the flat wiring member, the flat wiring member may be damaged. Moreover, the attachment direction with respect to the electric conductor of the flat wiring member is limited to one side, and hence there are concerns regarding contact reliability with respect to the electric conductor.

The present disclosure has been made in view of such a problem in the related art. Further, an object of the present disclosure is to provide a connector-equipped wire harness and a method of manufacturing the connector-equipped wire harness that can enhance contact reliability of terminals while facilitating assembly work.

A connector-equipped wire harness according to an aspect of the present disclosure includes: a flat wiring member including an electric conductor; a flat wiring member-dedicated terminal including an electric connection portion that is electrically connected to a mating terminal and a narrow insertion portion that clamps the flat wiring member; and a connector housing configured to nip the flat wiring member-dedicated terminal, wherein by nipping the flat wiring member-dedicated terminal by the connector housing while the flat wiring member is inserted into the narrow insertion portion, the electric conductor is clamped by the narrow insertion portion and the flat wiring member-dedicated terminal and the electric conductor are electrically connected to each other.

A method of manufacturing a connector-equipped wire harness according to another aspect of the present disclosure includes: a step of inserting the flat wiring member into the narrow insertion portion of the flat wiring member-dedicated terminal while the flat wiring member-dedicated terminal is arranged inside the connector housing; and a step of clamping the electric conductor by the narrow insertion portion by nipping the flat wiring member-dedicated terminal by the connector housing while the flat wiring member is inserted into the narrow insertion portion.

According to the present disclosure, it is possible to provide a connector-equipped wire harness and a method of manufacturing the connector-equipped wire harness that can enhance contact reliability of terminals while facilitating assembly work.

### BRIEF DESCRIPTION OF DRAWINGS

FIG. 1 is a plan view schematically illustrating an example of a flat wiring member provided to a connector-equipped wire harness according to the present embodiment.

FIG. 2 is a perspective view schematically illustrating an example of a flat wiring member-dedicated terminal provided to the connector-equipped wire harness according to the present embodiment.

FIG. 3 is a cross-sectional view schematically illustrating an example of a connector provided to the connector-equipped wire harness according to the present embodiment.

FIG. 4A is a cross-sectional view taken along the line IVA-IVA in FIG. 4B, illustrating a state before the flat wiring member is inserted into the flat wiring member-dedicated terminal in the connector-equipped wire harness.

FIG. 4B is a plan view illustrating the state before the flat wiring member is inserted into flat wiring member-dedicated terminal in the connector-equipped wire harness.

FIG. 5A is a cross-sectional view taken along the line VA-VA in FIG. 5B, illustrating a state in which the flat wiring member is inserted into flat wiring member-dedicated terminal in the connector-equipped wire harness.

FIG. 5B is a plan view illustrating the state in which the flat wiring member is inserted into flat wiring member-dedicated terminal in the connector-equipped wire harness.

FIG. 6A is a cross-sectional view taken along the line VIA-VIA in FIG. 6B, illustrating a state in which flat wiring member-dedicated terminal is nipped by a connector housing after inserting the flat wiring member into flat wiring member-dedicated terminal in the connector-equipped wire harness.

FIG. 6B is a plan view illustrating the state in which flat wiring member-dedicated terminal is nipped by the connector housing after inserting the flat wiring member into flat wiring member-dedicated terminal in the connector-equipped wire harness.

### DETAILED DESCRIPTION OF THE INVENTION

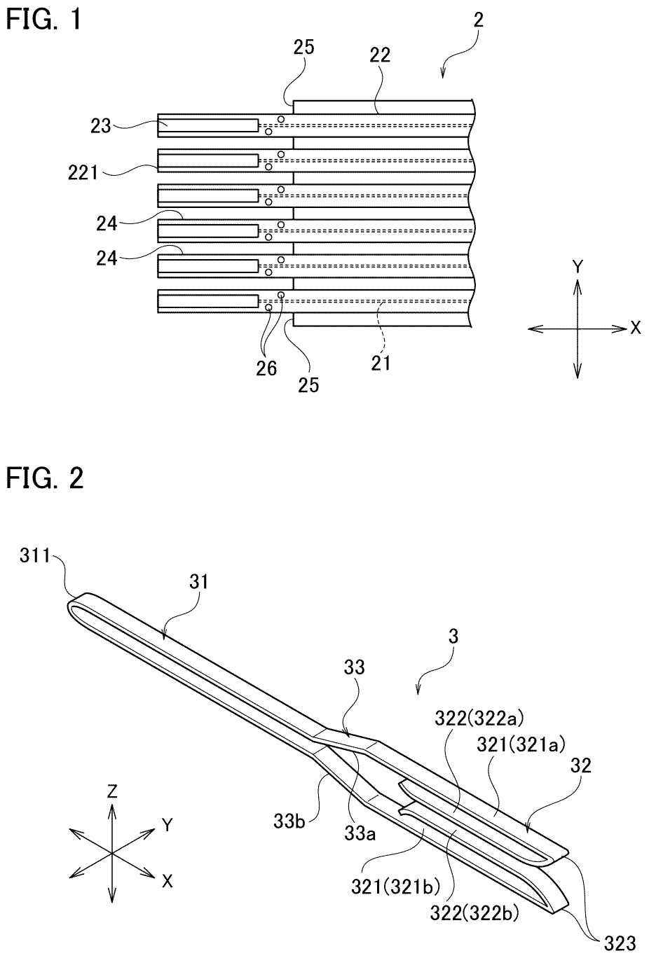

With reference to the drawings, a connector-equipped wire harness according to the present embodiment is described below in detail. Note that the dimensional ratios in the drawings are exaggerated for explanatory purposes, and may differ from the actual ratios. Further, for the explanatory purposes, a front-rear direction X, a width direction Y, and an up-down direction Z are defined as illustrated in FIG. 1 to FIG. 6B. The front-rear direction X, the width direction Y, and the up-down direction Z are orthogonal to one another. Note that the front-rear direction corresponds to a length direction of the present embodiment, and the up-down direction corresponds to a thickness direction of the present embodiment.

A connector-equipped wire harness 1 of the present embodiment includes a flat wiring member 2, a flat wiring member-dedicated terminal 3 that is connected to a terminal end of the flat wiring member 2, a connector housing 4 that accommodates the terminal end of the flat wiring member 2 and the flat wiring member-dedicated terminal 3. Further, the flat wiring member-dedicated terminal 3 and the connector housing 4 form a connector 5.

As illustrated in FIG. 1, the flat wiring member 2 includes a plurality of electric conductors 21 that are arrayed at an interval in the width direction Y and an insulating sheet 22 that covers the periphery of the plurality of electric conductors 21, and has a sheet-like shape as a whole. The electric conductor 21 is formed of an electroconductive material, and is formed of, for example, an electroconductive metal foil. The insulating sheet 22 is formed of an electrically insulating material, and is formed of, for example, an electrically insulating resin. Examples of the flat wiring member 2 include a flexible printed circuit (FPC), a flexible flat cable (FFC), and a printed circuit.

The insulating sheet 22 on the upper side and the lower side of a terminal end is removed from the flat wiring member 2, and the plurality of electric conductors 21 on the upper side and the lower side of the terminal end are partially exposed. Moreover, the exposed part is provided with a strip-like land 23 that is formed integrally with the electric conductor 21. The land 23 is formed of an electroconductive material, and is formed of, for example, an electroconductive metal foil. The land 23 is formed by widening the electric conductor 21 of the terminal end, and enhances electrical conductivity when the flat wiring member-dedicated terminal 3 is brought into contact with the land 23 as described later. Note that, in the present embodiment, six electric conductors 21 and six lands 23 are provided.

The flat wiring member 2 is provided with a cut-out portion 24 between the lands 23 that are adjacent to each other. The cut-out portion 24 is formed by cutting the insulating sheet 22 along the front-rear direction X from a front end 221 of the insulating sheet 22. Further, on each side of the flat wiring member 2 in the width direction Y, a locking recess portion 25 formed by cutting the insulating sheet 22 along the front-rear direction X is provided. Note that the cut-out portion 24 and the locking recess portion 25 have substantially the same length in the front-rear direction X.

On the rear side of the land 23 in the front-rear direction X (the right side in FIG. 1), an engagement hole 26 is provided. The engagement hole 26 is formed by passing through the insulating sheet 22. Two engagement holes 26 are provided to one electric conductor 21 on both sides of the electric conductor 21 in the width direction Y, and the two engagement holes 26 are provided at positions different from each other along the front-rear direction X.

As described later, the land 23 and the engagement hole 26 are inserted into the connector housing 4, and hence are provided on the front side in the front-rear direction X with respect to a terminal end of the cut-out portion 24 (the left side in FIG. 1).

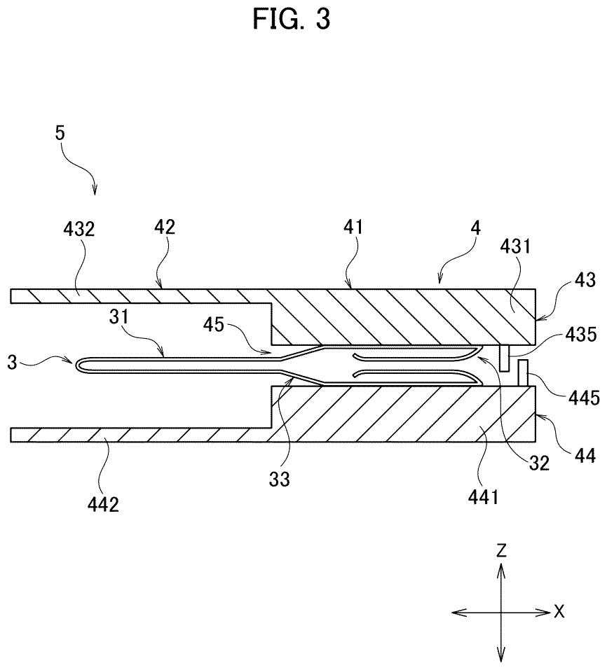

The flat wiring member-dedicated terminal 3 is formed of an electroconductive metal material, and can be formed by bending an elongated metal plate. As illustrated in FIG. 2, the flat wiring member-dedicated terminal 3 includes an electric connection portion 31 that is electrically connected to a mating terminal and a narrow insertion portion 32 that clamps the flat wiring member 2. Further, the electric connection portion 31 and the narrow insertion portion 32 are connected integrally to each other via a taper portion 33.

The electric connection portion 31 of the flat wiring member-dedicated terminal 3 is formed by bending an elongated metal plate and stacking it in two layers. In other words, the electric connection portion 31 is formed by two flat plates extending from a bent portion 311 toward the rear side in the front-rear direction. Further, the electric connection portion 31 can be electrically connected to the mating terminal through direct contact with the mating terminal formed of, for example, a female terminal.

The taper portion 33 is gradually expanded in the up-down direction Z as approaching the rear side in the front-rear direction X by bending the connection portion with the electric connection portion 31.

The narrow insertion portion 32 includes a flat plate-like portion 321 that extends rearward from the rear end of the taper portion 33 and an elastic contact portion 322 that extends frontward from the rear end of the flat plate-like portion 321 and has a flat plate-like shape. At the rear end of the flat plate-like portion 321, a folded portion 323 that is curved toward the electric connection portion 31 is provided. The elastic contact portion 322 is formed by being folded at the folded portion 323 and extending from the flat plate-like portion 321 toward the electric connection portion 31. Therefore, the flat plate-like portion 321 and the elastic contact portion 322 face each other at an interval in the up-down direction Z to form a double structure.

Further, the front end of the elastic contact portion 322 is a free end, and the rear end thereof is a fixed end that is integrated with the folded portion 323. Thus, the elastic contact portion 322 is in a form of a plate spring.

the narrow insertion portion 32 includes an upper flat plate-like portion 321a and an upper elastic contact portion 322a that are connected to an upper taper portion 33a and a lower flat plate-like portion 321b and a lower elastic contact portion 322b that are connected to a lower taper portion 33b. Note that the front end of the upper elastic contact portion 322a is curved toward the upper flat plate-like portion 321a, and the front end of the lower elastic contact portion 322b is curved toward the lower flat plate-like portion 321b. Thus, the upper elastic contact portion 322a can be elastically deformed until the front end thereof contacts with the upper flat plate-like portion 321a, and the lower elastic contact portion 322b can be elastically deformed until the front end thereof contacts with the lower flat plate-like portion 321b.

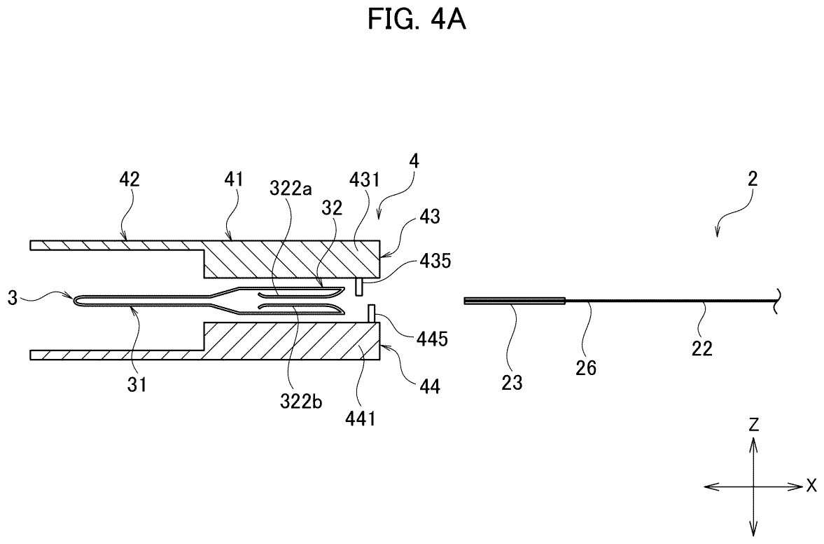

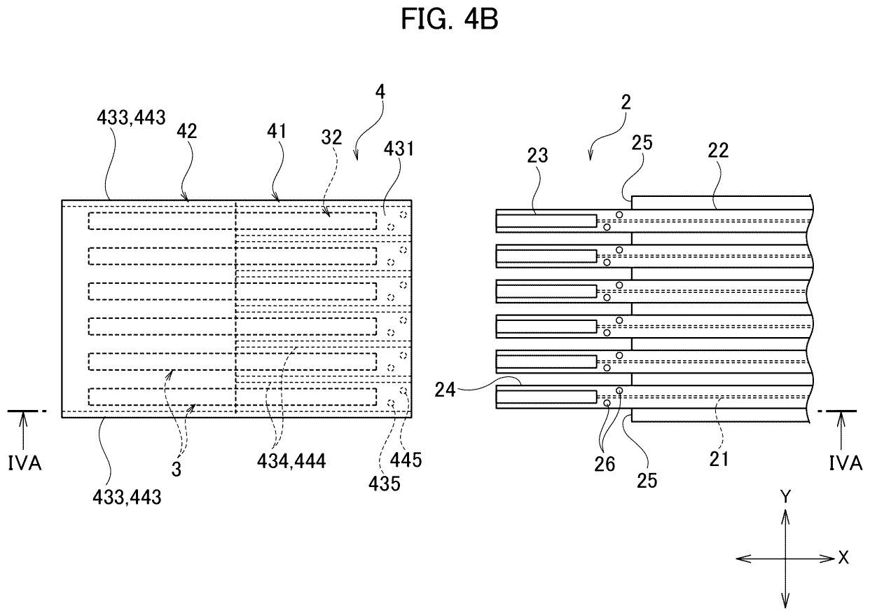

As illustrated in FIG. 3 and FIG. 4B, the connector housing 4 includes a terminal retention portion 41 that retains the plurality of flat wiring member-dedicated terminals 3 and a mating connector accommodation chamber 42 that accommodates a mating connector. The connector housing 4 is divided into an upper section and a lower section, and includes an upper connector housing 43 and a lower connector housing 44. Further, as described later, the connector 5 is formed by fitting the upper connector housing 43 and the lower connector housing 44 to each other while the flat wiring member-dedicated terminal 3 is arranged inside. Note that the connector housing 4 is formed of an electrically insulating material, and is formed of, for example, an electrically insulating resin.

As illustrated in FIG. 3, an upper terminal retention portion 431 of the upper connector housing 43 and a lower terminal retention portion 441 of the lower connector housing 44 form the terminal retention portion 41. The mating connector accommodation chamber 42 is defined by an upper wall 432 of the upper connector housing 43, a lower wall 442 of the lower connector housing 44, side walls 433 of the upper connector housing 43 on both sides in the width direction Y, and side walls 443 of the lower connector housing 44 on both sides in the width direction Y.

As illustrated in FIG. 4B, in the terminal retention portion 41, the plurality of flat wiring member-dedicated terminals 3 are arrayed at an interval in the width direction Y. A partition wall 434 of the upper connector housing 43 and a partition wall 444 of the lower connector housing 44 are formed between the flat wiring member-dedicated terminal 3 that are adjacent to each other.

Inside the terminal retention portion 41, a terminal accommodation chamber 45 is defined by the upper terminal retention portion 431 of the upper connector housing 43, the lower terminal retention portion 441 of the lower connector housing 44, the partition wall 434 of the upper connector housing 43, and the partition wall 444 of the lower connector housing 44. Further, on both sides of the terminal retention portion 41, the terminal accommodation chamber 45 is defined by the upper terminal retention portion 431, the lower terminal retention portion 441, the side walls 433 and the partition wall 434 of upper connector housing 43, and the side walls 443 and the partition wall 444 of the lower connector housing 44.

As illustrated in FIG. 3, in the up-down direction Z, the thickness of the upper terminal retention portion 431 of the upper connector housing 43 is larger than the thickness of the upper wall 432. Similarly, the thickness of the lower terminal retention portion 441 of the lower connector housing 44 is larger than the thickness of the lower wall 442.

The terminal accommodation chamber 45 accommodates the narrow insertion portion 32 and the taper portion 33 of the flat wiring member-dedicated terminal 3, and the electric connection portion 31 of the flat wiring member-dedicated terminal 3 protrudes from the terminal accommodation chamber 45 toward the mating connector accommodation chamber 42. The mating connector and the mating terminal (omitted in illustration) are inserted into the mating connector accommodation chamber 42, and the mating terminal contacts with and is electrically connected to the electric connection portion 31 of the flat wiring member-dedicated terminal 3.

An upper engagement protrusion 435 is provided on the rear side of the upper connector housing 43 in the front-rear direction X. In other words, on the rear side of the upper terminal retention portion 431 with respect to the narrow insertion portion 32 of the flat wiring member-dedicated terminal 3, the upper engagement protrusion 435 is provided to protrude downward from the upper terminal retention portion 431. Similarly, a lower engagement protrusion 445 is provided on the rear side of the lower connector housing 44 in the front-rear direction X. In other words, on the rear side of the lower terminal retention portion 441 with respect to the narrow insertion portion 32 of the flat wiring member-dedicated terminal 3, the lower engagement protrusion 445 is provided to protrude upward from the lower terminal retention portion 441.

One upper engagement protrusion 435 and one lower engagement protrusion 445 are provided for each of the flat wiring member-dedicated terminals 3. Further, as described later, the upper engagement protrusion 435 and the lower engagement protrusion 445 are respectively inserted into the two engagement holes 26 of the flat wiring member 2.

Note that the upper engagement protrusion 435 and the lower engagement protrusion 445 are provided at positions different from each other along the front-rear direction X and the width direction Y. Further, the interval between the upper engagement protrusion 435 and the lower engagement protrusion 445 in the front-rear direction X and the width direction Y is the same as the interval between the two engagement holes 26 of the flat wiring member 2.

Description is made on a method of manufacturing the connector-equipped wire harness 1 by using the flat wiring member 2, the flat wiring member-dedicated terminal 3, and the connector housing 4.

First, as illustrated in FIG. 4A, the narrow insertion portion 32 of the flat wiring member-dedicated terminal 3 is arranged between the upper terminal retention portion 431 of the upper connector housing 43 and the lower terminal retention portion 441 of the lower connector housing 44. At the same time, the electric connection portion 31 of the flat wiring member-dedicated terminal 3 is arranged in the mating connector accommodation chamber 42 of the connector housing 4. Note that, in this state, the narrow insertion portion 32 of the flat wiring member-dedicated terminal 3 is not pressed by the upper terminal retention portion 431 and the lower terminal retention portion 441. Thus, there is a gap between the upper elastic contact portion 322a and the lower elastic contact portion 322b of the narrow insertion portion 32. Further, there is also a gap between the upper engagement protrusion 435 of the upper connector housing 43 and the lower engagement protrusion 445 of the lower connector housing 44 in the up-down direction Z.

Subsequently, as illustrated in FIG. 4A and FIG. 4B, the flat wiring member 2 is arranged on the rear side of the connector housing 4 in the front-rear direction X (the right side in FIG. 4A and FIG. 4B). In this state, the flat wiring member 2 is arranged so that the land 23 of the flat wiring member 2 faces the connector housing 4.

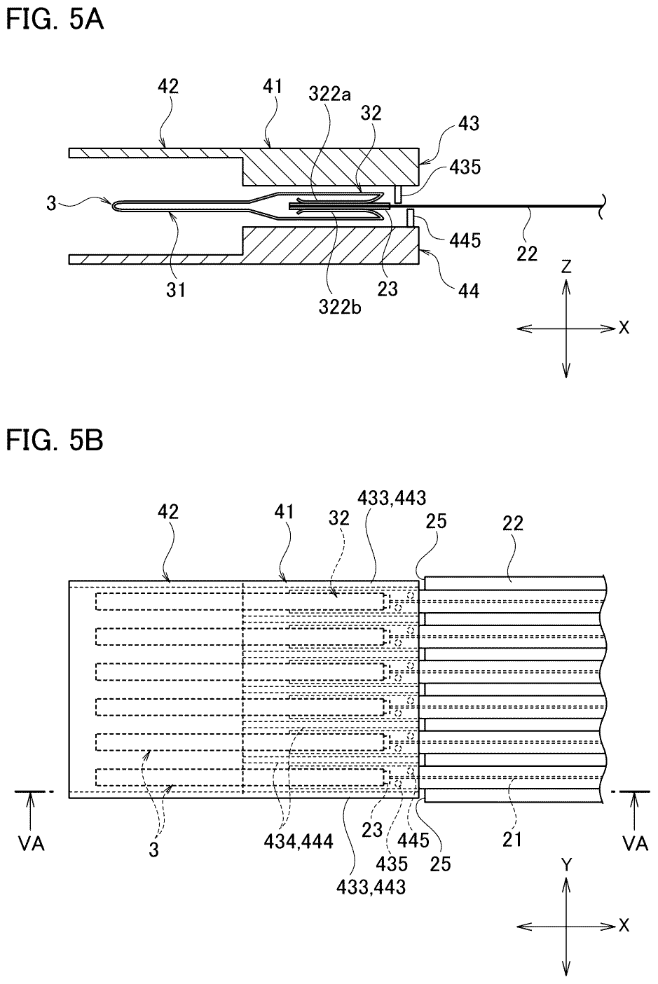

Subsequently, as illustrated in FIG. 5A and FIG. 5B, the terminal end of the flat wiring member 2 is inserted into the narrow insertion portion 32 of the flat wiring member-dedicated terminal 3 and the terminal retention portion 41 of the connector housing 4. In this state, the locking recess portion 25 of the flat wiring member 2 abuts against the side walls 433 of the upper connector housing 43 and/or the side walls 443 of the lower connector housing 44. Thus, when the terminal end of the flat wiring member 2 is inserted into the narrow insertion portion 32 of the flat wiring member-dedicated terminal 3 and the terminal retention portion 41 of the connector housing 4, movement in the insertion direction is restricted. In other words, the locking recess portion 25 of the flat wiring member 2 functions as a stopper. As a result, as illustrated in FIG. 5B, the two engagement holes 26 of the flat wiring member 2, and the upper engagement protrusion 435 and the lower engagement protrusion 445 face each other, and hence positioning of those elements is facilitated. Further, the land 23 of the flat wiring member 2, and the upper elastic contact portion 322a and the lower elastic contact portion 322b of the narrow insertion portion 32 face each other, and hence positioning of those elements is also facilitated.

Further, the partition wall 434 of the upper connector housing 43 and/or the partition wall 444 of the lower connector housing 44 is/are inserted into the cut-out portion 24 of the flat wiring member 2.

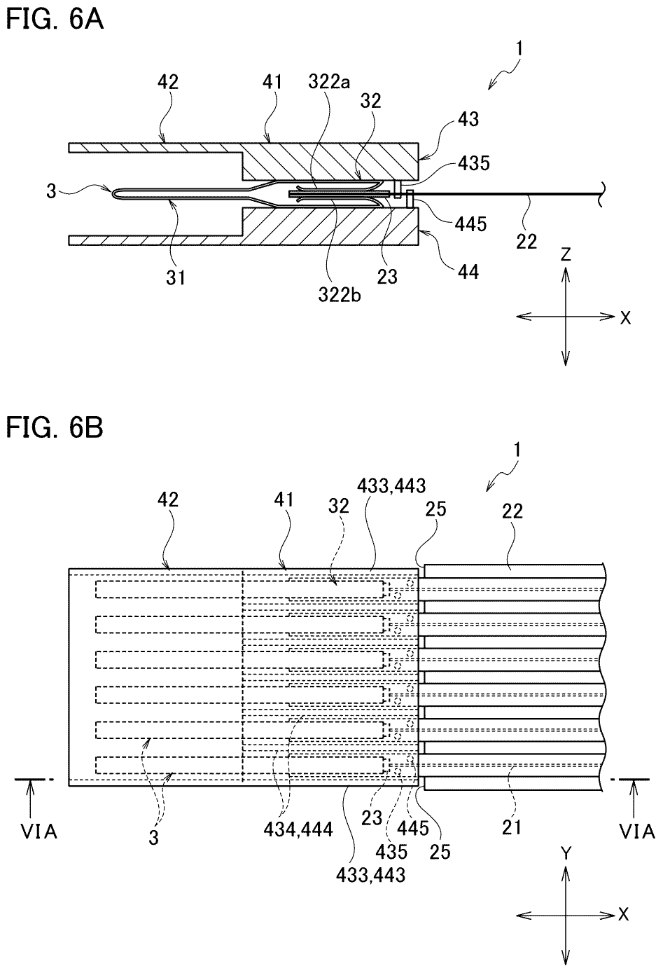

Further, as illustrated in FIG. 6A and FIG. 6B, while the flat wiring member 2 is inserted into the narrow insertion portion 32 of the flat wiring member-dedicated terminal 3, the flat wiring member-dedicated terminal 3 is nipped by the upper terminal retention portion 431 of the upper connector housing 43 and the lower terminal retention portion 441 of the lower connector housing 44. In this state, the upper elastic contact portion 322a and the lower elastic contact portion 322b of the narrow insertion portion 32 are elastically deformed, and the upper elastic contact portion 322a and the lower elastic contact portion 322b are brought into close contact with the land 23. In this manner, the narrow insertion portion 32 of the flat wiring member-dedicated terminal 3 clamps the land 23 of the flat wiring member 2. As a result, the flat wiring member-dedicated terminal 3 and the electric conductor 21 are electrically connected to each other.

Further, when the flat wiring member-dedicated terminal 3 is nipped by the upper terminal retention portion 431 and the lower terminal retention portion 441, the upper engagement protrusion 435 and the lower engagement protrusion 445 are respectively inserted into the two engagement holes 26 of the flat wiring member 2. As a result, the flat wiring member 2 is locked and fixed to the connector housing 4.

After that, the upper connector housing 43 and the lower connector housing 44 are fitted to each other, and then the fitting state is retained by a lock or the like that is additionally provided. In this manner, the connector-equipped wire harness 1 in which the flat wiring member-dedicated terminal 3 and the connector housing 4 are attached to the flat wiring member 2 can be obtained.

As described above, the connector-equipped wire harness 1 of the present embodiment includes the flat wiring member 2 including the electric conductor 21 and the flat wiring member-dedicated terminal 3 including the electric connection portion 31 that is electrically connected to the mating terminal and the narrow insertion portion 32 that clamps the flat wiring member 2. The connector-equipped wire harness 1 further includes the connector housing 4 that nips the flat wiring member-dedicated terminal 3. Further, by nipping the flat wiring member-dedicated terminal 3 by the connector housing 4 while the flat wiring member 2 is inserted into the narrow insertion portion 32, the electric conductor 21 is clamped by the narrow insertion portion 32 and the flat wiring member-dedicated terminal 3 and the electric conductor 21 are electrically connected to each other.

The connector-equipped wire harness 1 includes the flat wiring member-dedicated terminal 3 that is simple and cost-effective and can handle the flat wiring member 2 such as an FPC, an FFC, and a printed circuit, and further includes the structure of clamping the flat wiring member-dedicated terminal 3 vertically by using the connector housing 4. The flat wiring member-dedicated terminal 3 has the spring structures on the upper side and the lower side, and can be brought into conduction with the circuit (the electric conductor 21), which is provided to the flat wiring member 2, in both the upper and lower directions. Further, since the flat wiring member-dedicated terminal 3 alone does not exert satisfactory retention force for the flat wiring member 2, the connector housing 4 is used to perform vertical clamping. With this configuration, contact reliability between the circuit provided to the flat wiring member 2 and the flat wiring member-dedicated terminal 3 can be enhanced.

Further, work for attaching the flat wiring member 2 to the flat wiring member-dedicated terminal 3 and the connector housing 4 only involves movement in the right-left direction and the up-down direction, and hence production automation can be facilitated.

In the connector-equipped wire harness 1 of the present embodiment, the connector housing 4 includes the engagement protrusion (the upper engagement protrusion 435, the lower engagement protrusion 445), and the flat wiring member 2 includes the engagement hole 26 into which the engagement protrusion is inserted. Further, the engagement protrusion is inserted into the engagement hole 26 by nipping the flat wiring member-dedicated terminal 3 by the connector housing 4, and the flat wiring member 2 is locked to the connector housing 4.

In the connector-equipped wire harness 1, the engagement protrusion 435, 445 of the connector housing 4 enters the engagement hole 26 of the flat wiring member 2, and hence detachment in the pulling direction (the front-rear direction X) is less likely to occur. Thus, connection reliability of the circuit provided to the flat wiring member 2 and the flat wiring member-dedicated terminal 3 can be enhanced.

In the connector-equipped wire harness 1 of the present embodiment, the flat wiring member 2 includes the locking portion (the locking recess portion 25) that abuts against the locked portion (the side walls 433, 443) of the connector housing 4 to restrict insertion into the connector housing 4.

In the connector-equipped wire harness 1, when the terminal end of the flat wiring member 2 is inserted into the narrow insertion portion 32 of the flat wiring member-dedicated terminal 3 and the connector housing 4, the movement in the insertion direction is restricted by the configuration described above. As a result, the engagement hole 26 of the flat wiring member 2 and the engagement protrusion 435, 445 face each other, and hence positioning of those elements is also facilitated.

In the connector-equipped wire harness 1 of the present embodiment, the narrow insertion portion 32 of the flat wiring member-dedicated terminal 3 includes the plate spring portion (the elastic contact portion 322) that is elastically deformable in the thickness direction of the flat wiring member 2.

In the connector-equipped wire harness 1, the narrow insertion portion 32 of the flat wiring member-dedicated terminal 3 is in a form of a plate spring. Thus, even when vibration or the like is applied, satisfactory contact between the circuit provided to the flat wiring member 2 and the flat wiring member-dedicated terminal 3 can be maintained.

The method of manufacturing the connector-equipped wire harness 1 of the present embodiment includes a step of inserting the flat wiring member 2 into the narrow insertion portion 32 of the flat wiring member-dedicated terminal 3 while the flat wiring member-dedicated terminal 3 is arranged inside the connector housing 4. The manufacturing method further includes a step of clamping the electric conductor 21 by the narrow insertion portion 32 by nipping the flat wiring member-dedicated terminal 3 by the connector housing 4 while the flat wiring member 2 is inserted into the narrow insertion portion 32.

In the related art, a terminal and a flat wiring member are connected to each other, the terminal is inserted into a connector, and then a step of integrating the flat wiring member and the connector is performed, which makes assembly work complicated. In contrast, in the connector-equipped wire harness 1, the flat wiring member-dedicated terminal 3 is arranged in the connector housing 4, the flat wiring member 2 is inserted into the flat wiring member-dedicated terminal 3, and then the flat wiring member-dedicated terminal 3 is clamped by the connector housing 4. In other words, the flat wiring member 2 is connected to the flat wiring member-dedicated terminal 3, and is integrated with the connector housing 4 at the same time. Therefore, in the connector-equipped wire harness 1, assembly work for attaching the flat wiring member-dedicated terminal 3 and the connector housing 4 to the flat wiring member 2 can be facilitated.

While the present embodiment is described above, the present embodiment is not limited thereto, and various modifications can be made within the scope of the gist of the present embodiment.

For example, the electric connection portion 31 of the flat wiring member-dedicated terminal 3 has a male shape, and may be a female shape instead. Further, the flat wiring member-dedicated terminal 3 can be brought into conduction with the circuits (the electric conductor 21 and the land 23), which are provided to the flat wiring member 2, in both the upper and lower directions. However, the flat wiring member-dedicated terminal 3 is only required to be brought into conduction with the circuits (the electric conductor 21 and the land 23), which are provided to the flat wiring member 2, in one of the upper and lower directions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector-equipped wire harness comprising:
a flat wiring member including an electric conductor;
a flat wiring member-dedicated terminal including an electric connection portion that is electrically connected to a mating terminal and a narrow insertion portion that clamps the flat wiring member; and
a connector housing configured to nip the flat wiring member-dedicated terminal, wherein
by nipping the flat wiring member-dedicated terminal by the connector housing while the flat wiring member is inserted into the narrow insertion portion, the electric conductor is clamped by the narrow insertion portion and the flat wiring member-dedicated terminal and the electric conductor are electrically connected to each other.

2. The connector-equipped wire harness according to claim 1, wherein
the connector housing includes an engagement protrusion, and the flat wiring member includes an engagement hole into which the engagement protrusion is inserted, and
the engagement protrusion is inserted into the engagement hole by nipping the flat wiring member-dedicated terminal by the connector housing, and the flat wiring member is locked to the connector housing.

3. The connector-equipped wire harness according to claim 1, wherein
the flat wiring member includes a locking portion that abuts against a locked portion of the connector housing to restrict insertion into the connector housing.

4. The connector-equipped wire harness according to claim 1, wherein
the narrow insertion portion includes a plate spring portion that is elastically deformable in a thickness direction of the flat wiring member.

5. A method of manufacturing a connector-equipped wire harness, the method being executed to manufacture the connector-equipped wire harness according to claim 1 and comprising:
inserting the flat wiring member into the narrow insertion portion of the flat wiring member-dedicated terminal while the flat wiring member-dedicated terminal is arranged inside the connector housing; and
clamping the electric conductor by the narrow insertion portion by nipping the flat wiring member-dedicated terminal by the connector housing while the flat wiring member is inserted into the narrow insertion portion.
